(19) United States
(12) Patent Application Publication
(10) Pub. No.: US 2003/0216915 A1
(43) Pub. Date: Nov. 20, 2003

(54) Voice command and voice recognition for hand-held devices

(76) Inventor: Jianlei Xie, Carmel, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/146,406

(22) Filed: May 15, 2002

(51) Int. Cl. G10L 17/00

(52) U.S. Cl. 704/246

(57) ABSTRACT

There is provided an Ebook. The Ebook includes a memory device, a command recognition module, and a processor. The memory device stores files. The files include text. The command recognition module recognizes spoken commands. The processor implements the spoken commands.

### CROSS-REFERENCE TO RELATED APPLICATIONS

This application is related to the applications, Attorney Docket Numbers IU000025, IU010084, and IU010086, respectively entitled “Talking Ebook”, “Text-To-Speech (TTS) for Hand-Held Devices”, and “Mixing Music and Text-To-Speech (TTS) for Hand-Held Devices”, which are commonly assigned and concurrently filed herewith, and the disclosures of which are incorporated herein by reference.

### BACKGROUND OF THE INVENTION

1. Field of the Invention

The present invention generally relates to hand-held devices and, more particularly, to voice command and voice recognition for hand-held devices.

2. Background of the Invention

An electronic book (also referred to as an “Ebook”) is an electronic version of a traditional print book (or other printed material such as, for example, a magazine, newspaper, and so forth) that can be read by using a personal computer or by using an Ebook reader. Unlike PCs or handheld computers, Ebook readers deliver a reading experience comparable to traditional paper books, while adding powerful electronic features for note taking, fast navigation, and key word searches. However, such actions, irrespective of whether or not they are performed on a PC, handheld computer, or Ebook reader, generally require the user to actuate buttons or use a remote control. Thus, the use of an Ebook generally requires the user to use one or more of his or her hands. Moreover, the use of any hand-held device requires the user to use one or more of his or her hands.

Accordingly, it would be desirable and highly advantageous to have a hand-held device such as, for example, an Ebook, that allows for hand-free operation.

### SUMMARY OF THE INVENTION

The problems stated above, as well as other related problems of the prior art, are solved by the present invention, a hand-held device having command recognition and voice recognition and a method for controlling a hand-held device using command recognition and voice recognition. Voice commands allow a user to control a hand-held device by simply speaking commands through an audio input device rather than by using the buttons or remote control. Voice recognition allows for the tracking of individual user actions and for the management and allocation of hand-held device resources and features based on user identity. Thus, the use of command recognition and voice recognition advantageously provide a user with hands-free control of hand-held device operations.

According to an aspect of the present invention, there is provided an Ebook. The Ebook comprises a memory device, a command recognition module, and a processor. The memory device stores files. The files include text. The command recognition module recognizes spoken commands. The processor implements the spoken commands.

According to another aspect of the present invention, there is provided a method for controlling an Ebook. Spoken commands are received from one or more users of the Ebook. The spoken commands are recognized. The Ebook is controlled based on the spoken commands.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating a computer system 100 to which the present invention may be applied, according to an illustrative embodiment of the present invention;

FIG. 2 is a block diagram illustrating an Ebook 200, according to an illustrative embodiment of the present invention; and

FIG. 3 is a flow diagram illustrating a method for controlling an Ebook having command recognition and voice recognition, according to an illustrative embodiment of the present invention.

### DETAILED DESCRIPTION OF THE INVENTION

The present invention is directed to a hand-held device having command recognition and voice recognition and to a method for controlling a hand-held device using command recognition and voice recognition. It is to be appreciated that the present invention is directed to any type of hand-held device including, but not limited to, electronic books (Ebooks), personal digital assistants (PDAs), and so forth. However, for the purposes of describing the present invention, the following description will be provided with respect to Ebooks.

Voice commands allow a user to control the Ebook by speaking commands through an audio input device rather than by using buttons or a remote control, thereby giving the user hands-free control of Ebook operations. Further, the implementation of text-to-speech (TTS) synthesis in addition to command and voice recognition provides a very useful tool for Ebook applications where it is not desirable for the user to look at a display (e.g., while driving).

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

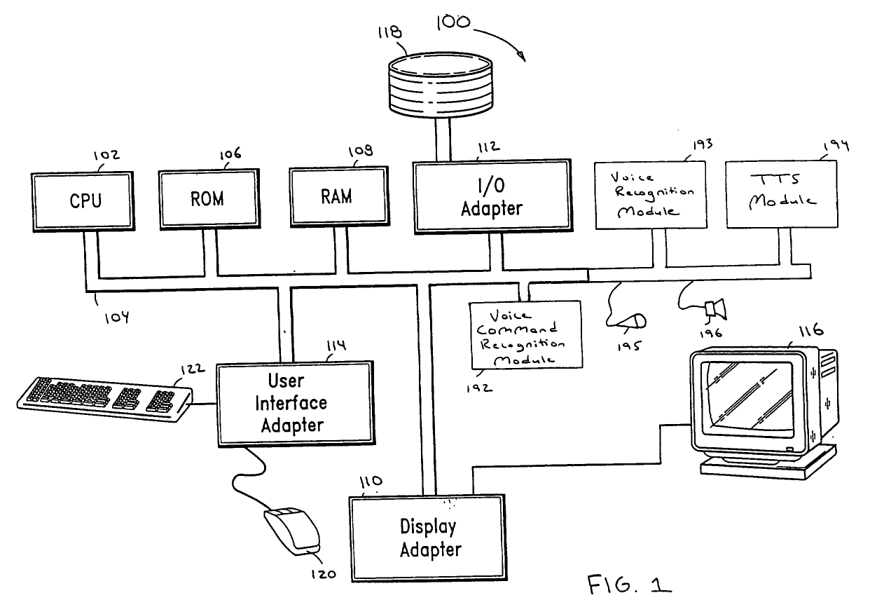

FIG. 1 is a block diagram illustrating a computer system 100 to which the present invention may be applied, according to an illustrative embodiment of the present invention. The computer processing system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

The computer system 100 further includes a voice command recognition module 192, a voice recognition module 193, a text-to-speech (TTS) module 194, a microphone 195, and a speaker 196.

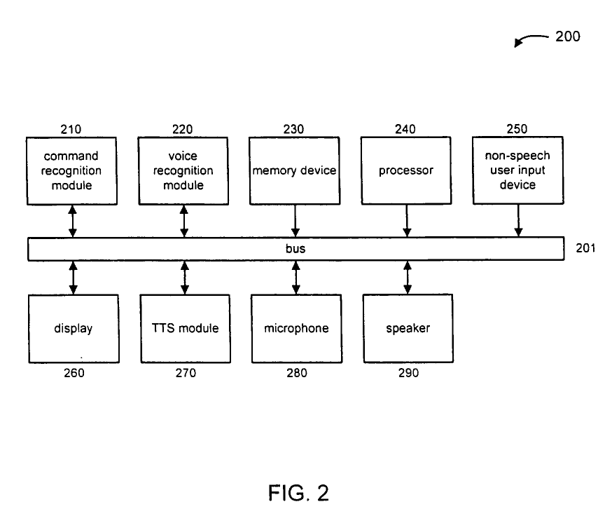

FIG. 2 is a block diagram illustrating an Ebook 200, according to an illustrative embodiment of the present invention. The Ebook 200 includes the following elements interconnected by bus 201: a command recognition module 210; a voice recognition module 220; at least one memory device (hereinafter “memory device” 230); at least one processor (hereinafter “processor” 240); an optional non-speech user input device 250 (e.g., keyboard, keypad, and/or remote control); a display 260; a text-to-speech (TTS) module 270; a microphone 280; and a speaker 290. Given the teachings of the present invention provided herein, one of ordinary skill in the related art will contemplate these and various other configurations of the computer system 100 and Ebook 200 respectively shown in FIGS. 1 and 2, while maintaining the spirit and scope of the present invention. It is to be appreciated that as used herein the term “Ebook” refers to either a standalone Ebook device (e.g., Ebook 200) or an Ebook included in a computer system (e.g., computer system 100).

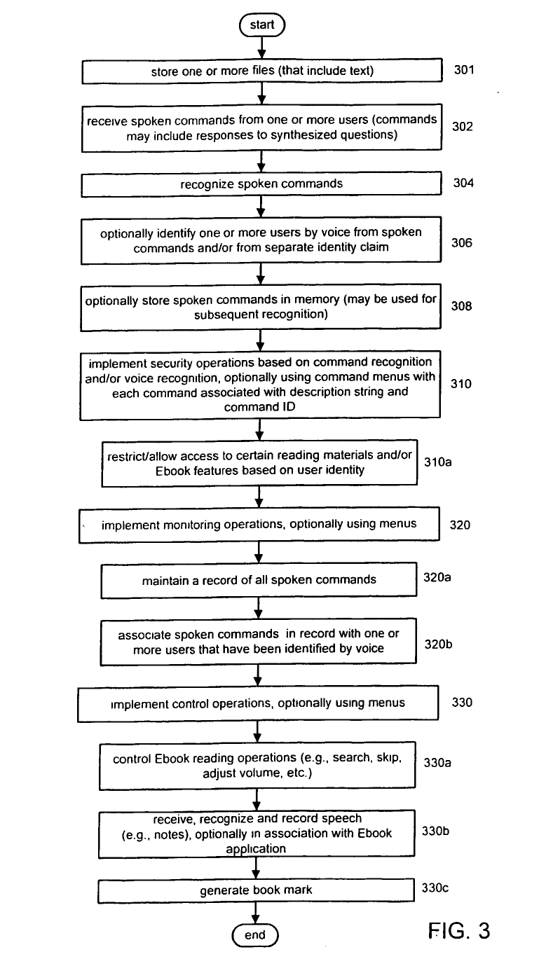

FIG. 3 is a flow diagram illustrating a method for controlling an Ebook having command recognition and voice recognition, according to an illustrative embodiment of the present invention.

One or more files are stored in the Ebook (step 301). The one or more files include at least text, and may also include graphics.

Spoken commands are received from one or more users (hereinafter “user”) of the Ebook (step 302). The spoken commands are recognized (step 304). Optionally, the identity of the user may be identified by voice from the spoken commands and/or from a separate identity claim (step 306).

At step 310, security operations may be implemented on the Ebook using command recognition and/or voice recognition. For example, step 310 may include the step of restricting/allowing access to certain materials (e.g., certain files) and/or Ebook features based on user identity (step 310b).

At step 320, monitoring operations may be implemented on the Ebook using command recognition and/or voice recognition. For example, step 320 may include the step of maintaining a record of all spoken commands (step 320a). Moreover, step 320 may include the step of associating each of the spoken commands in the record with one or more users of the Ebook that have been identified by their voice (step 320b). The recorded commands may be used in subsequent recognition sessions, particularly to decode a command spoken with a strong accent.

At step 330, control operations may be implemented on the Ebook using command recognition and/or voice recognition. For example, step 330 may include the step of controlling Ebook reading operations such as search, skip, adjust volume, and so forth (step 330a). The preceding list of operations is merely illustrative and, thus, other operations may also be controlled. For example, other operations may include navigating through a given reading material (e.g., a book, magazine, newspaper, and so forth), reading at least a portion of the reading material or synthesizing speech corresponding to the portion, annotating the reading material, and so forth. Thus, a user can provide simple commands to the Ebook such as “skip a chapter”, and can answer simple yes/no questions to control Ebook operations. More complex commands and/or questions can also be readily implemented by one of ordinary skill in the related while maintaining the spirit and scope of the present invention, given the teachings of the present invention provided herein. It is to be appreciated that the term “control” as used herein with respect to controlling an Ebook may encompass any one of steps 310-330.

It is to be further appreciated that, according to one illustrative embodiment of the present invention, step 330 (or any other step for that matter) may be implemented using voice menus. That is, similar to a remote control in behavior, the present invention may be configured to provide a “menu” of commands that users can speak. Basically, to use voice commands, an Ebook according to the present invention provides a voice menu(s) that corresponds to a remote control or one or more states within a given Ebook application. A list of voice commands that may be spoken by a user may be contained within each voice menu. When a user speaks a given command, the application is notified which command was spoken. For example, “skip a chapter”, “adjust volume higher”, and “read faster” are typical voice commands that may be used for enhanced Ebooks with Text To Speech (TTP) installed. Each voice command may include information in addition to the spoken command, such as a description string and a command ID.

It is to be appreciated that steps 310 through 330 may be performed in any order and in any combination to provide hands-free Ebook operation. Such hands-free Ebook operation may be provided, for example, to access a text file under certain circumstances such as, e.g., during a medical procedure, a machine shop specification search, while cooking (e.g., menu reading), driving, and so forth. Moreover, such hands-free Ebook operation may be provided for note taking, particularly during education applications (step 330b). Further, such hands-free Ebook operation may be provided to generate a mark (similar to a bookmark) on an Ebook with TTS such that the mark acts as a point to resume a subsequent reading of the Ebook (step 330c).

Although the illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. An Ebook, comprising:
a memory device for storing files, the files including text;
a command recognition module for recognizing spoken commands; and
a processor for implementing the spoken commands.

2. The Ebook of claim 1, further comprising a voice recognition module for recognizing voices and distinguishing user identities from the voices.

3. The Ebook of claim 2, wherein said voice recognition module restricts access to the file based upon a user identity.

4. The Ebook of claim 2, wherein said memory device logs at least some of the spoken commands recognized by said command recognition module in association with one or more speakers of the at least some of the spoken commands.

5. The Ebook of claim 4, wherein the at least some of the spoken commands logged by said memory device are used by said voice recognition module in a subsequent voice recognition session.

6. The Ebook of claim 1, wherein said command recognition module further recognizes spoken notes corresponding to the files, and said memory device stores the spoken notes.

7. The Ebook of claim 1, further comprising a text-to-speech (TTS) module for synthesizing speech, the speech including questions corresponding to a control of Ebook operations, and wherein said command recognition module further recognizes spoken responses to the questions.

8. The Ebook of claim 1, wherein said command recognition module employs one or more voice menus that include one or more of the spoken commands.

9. The Ebook of claim 8, wherein each of the one or more spoken commands included in the one or more voice menus is associated with a corresponding description string and a corresponding command ID.

10. The Ebook of claim 1, further comprising a microphone for receiving speech, the speech including the spoken commands.

11. The Ebook of claim 1, further comprising a display for displaying the text.

12. A method for controlling an Ebook, comprising the steps of:
receiving spoken commands from one or more users of the Ebook;
recognizing the spoken commands; and
controlling the Ebook based on the spoken commands.

13. The method of claim 12, further comprising the steps of recognizing voices of the one or more users and distinguishing user identities of the one or more users from the voices.

14. The method of claim 13, further comprising the step of restricting access to the at least one file based upon a user identity.

15. The method of claim 13, further comprising the step of logging at least some of the spoken commands in association with one or more speakers of the at least some of the spoken commands.

16. The method of claim 13, further comprising the step of employing in a subsequent voice recognition session the at least some of the spoken commands that have been logged.

17. The method of claim 12, further comprising the steps of:
storing at least one file in the Ebook, the at least one file including text;
recognizing spoken notes corresponding to the at least one file; and
storing the spoken notes.

18. The method of claim 12, wherein the Ebook comprises a text-to-speech (TTS) module for synthesizing speech, and said method further comprises the steps of:
synthesizing questions corresponding to a control of Ebook operations;
recognizing spoken responses to the questions; and
acting upon the spoken responses.

19. The method of claim 12, further comprising the step of generating one or more voice menus that include one or more of the spoken commands.

20. The method of claim 12, further comprising the step of associating each of the one or more spoken commands included in the one or more voice menus with a corresponding description string and a corresponding command ID.

21. A hand-held device, comprising:
a memory device for storing files, the files including text;
a command recognition module for recognizing spoken commands; and
a processor for implementing the spoken commands.

22. The hand-held device of claim 21, further comprising a voice recognition module for recognizing voices and distinguishing user identities from the voices.

23. The hand-held device of claim 22, wherein said voice recognition module restricts access to the file based upon a user identity.

24. The hand-held device of claim 22, wherein said memory device logs at least some of the spoken commands recognized by said command recognition module in association with one or more speakers of the at least some of the spoken commands.

25. The hand-held device of claim 24, wherein the at least some of the spoken commands logged by said memory device are used by said voice recognition module in a subsequent voice recognition session.

26. The hand-held device of claim 21, further comprising a text-to-speech (TTS) module for synthesizing speech, the speech including questions corresponding to a control of Ebook operations, and wherein said command recognition module further recognizes spoken responses to the questions.
